(19) United States
(12) Patent Application Publication
(10) Pub. No.: US 2013/0046087 A1
(43) Pub. Date: Feb. 21, 2013

(54) Substituted Cyclodextrin Derivatives Useful As Intermediates For Producing Biologically Active Materials

(71) Applicants: Serge Van Calenbergh, De Pinte (BE); Kiran Toti, Gent (BE); Eric Wilhelmus Petrus Damen, Nijmegen (NL)

(72) Inventors: Serge Van Calenbergh, De Pinte (BE); Kiran Toti, Gent (BE); Eric Wilhelmus Petrus Damen, Nijmegen (NL)

(73) Assignee: Arcarios BV, Rotterdam (NL)

(21) Appl. No.: 13/635,916

(22) PCT Filed: Mar. 23, 2011
(86) PCT No.: PCT/EP2011/054491

§ 371 Date: Sep. 19, 2012

(30) Foreign Application Priority Data
Mar. 24, 2010 (JP) 10157560.3

(51) Int. Cl. C08B 37/16

(52) U.S. Cl. 536/46; 536/103

(57) ABSTRACT

The present invention relates to substituted cyclodextrin derivatives which are particularly useful intermediates for producing well-defined carboxyalkylated cyclodextrins in contrast with the poorly-defined mixtures available through prior art procedures. The present invention also relates to processes for their preparation in a limited number of steps. These well-defined carboxyalkylated cyclodextrins can be polysulfated according to procedures standard in the art and some of these polysulfates, and alkali salts thereof, have been found to exhibit biologically active properties especially for the treatment and/or prophylaxis of degenerative joint diseases (e.g. osteoarthritis) or heparin-induced thrombocytopenia, or for cartilage repair or connective tissue repair.

### FIELD OF THE INVENTION

The present invention relates to substituted cyclodextrin derivatives which are particularly useful intermediates for producing well-defined carboxyalkylated cyclodextrins in contrast with the poorly-defined mixtures available through prior art procedures. The present invention also relates to processes for their preparation in a limited number of steps. These well-defined carboxyalkylated cyclodextrins can be polysulfated according to procedures standard in the art and some of these polysulfates, and alkali salts thereof, have been found to exhibit biologically active properties especially for the treatment and/or prophylaxis of degenerative joint diseases (e.g. osteoarthritis) or heparin-induced thrombocytopenia, or for cartilage repair or connective tissue repair.

### BACKGROUND OF THE INVENTION

Cyclodextrins make up a vast family of cyclic oligo- and polysaccharides containing 5 or more D-glucopyranoside units linked through 1-4 glycosidic bonds. The most typical cyclodextrins contain a set of 6 to 8 glucopyranoside units in a ring (hereinafter named the “cyclodextrin core”), creating a cone shape. Within this family, α-cyclodextrins have 6 glucopyranoside units, β-cyclodextrins have 7 glucopyranoside units, and γ-cyclodextrins have 8 glucopyranoside units in a ring. Each glucopyranoside unit has, according to the standard atom numbering system, one primary alcohol group at carbon 6 and two secondary alcohol groups at carbons 2 and 3. Numerous chemical modifications of cyclodextrins are known in the art, as summarized for instance by A. Croft and R. Bartsch in Tetrahedron Report No. 147, Tetrahedron (1983) 39(9):1417-1474. At pages 1461-1462 and table 31, this report states that many of cyclodextrin derivatives with attached carboxyl groups are mixtures in which varying numbers of the hydroxyl groups of the parent cyclodextrin have been functionalized. For instance U.S. Pat. No. 3,426,011 describes mixtures of carboxymethyl ethers of β-cyclodextrin with a degree of substitution of 0.066 (example 6) and mixtures of carboxyethyl ethers of β-cyclodextrin with degrees of substitution of 0.045 and 0.02 (examples 7 and 8). The only cyclodextrin carboxyalkyl ether derivative appearing at page 1463 (table 32) of the Tetrahedron report listing cyclodextrin derivatives with pendant carboxylic acid groups is mono[2(3)-O-(carboxymethyl)]-α-cyclodextrin, a compound wherein the carboxy-methyl group etherifies a secondary alcohol group of the glucopyranoside unit. This situation is also confirmed by commercial catalogues, e.g. from Cyclolab Ltd. (Hungary) wherein carboxymethylated cyclodextrins and carboxyethylated cyclodextrins are said to be randomly substituted with average degrees of substitution of about 3.5 and about 3 respectively.

Pearce et al in Angew. Chem. Int. Ed. (2000) 39:3610-3612 disclose the regioselective mono-de-O-benzylation and di-de-O-benzylation of perbenzylated cyclodextrins, the latter being disclosed by Sato et al in Carbohydr. Res. (1990) 199:31-35. This teaching opens a new route to the synthesis of well-defined modified cyclodextrins by further reacting the free primary hydroxyl group(s). Sato et al (cited supra) provide examples such as the corresponding bis-iodide, the 6A,6D-di-O-(methyl)-α-cyclodextrin derivative and the 6A,6D-di-O-(propenyl)-α-cyclodextrin derivative.

Medicinal uses of cyclodextrin polysulfates are already known for instance from U.S. Pat. No. 6,930,098 teaching the treatment of a human afflicted with arthrosis. According to Osteoarthritis and Cartilage (2008) 16:986-993, β-cyclodextrin polysulfate subcutaneously administered in a rabbit model of experimental osteoarthritis reduced the cartilage lesions and osteocyte formation in the affected joints. However the potency of β-cyclodextrin polysulfates to induce heparin-induced thrombocytopenia and thromboembolic accidents through cross reaction with heparin/platelet factor IV antibodies is a matter of concern in the use of cyclodextrin polysulfates in the treatment of arthrosis, i.e. to realize a reduction in the cartilage lesions and osteocyte formation of the affected joints. Therefore there is a need in the art for chemically modified β-cyclodextrin polysulfates with a preserved chondro-protective capacity, a reduced effect on coagulation and a reduced risk for heparin-induced thrombocytopenia. It is accordingly an object of the present invention to provide chemically modified cyclodextrin polysulfates, in particular β-cyclodextrin polysulfates which can be used for the treatment and/or prophylaxis of degenerative joint diseases such as osteoarthritis, articular rheumatism, arthrosis or degenerative arthritis, or for cartilage repair or connective tissue repair; but without the side-effects observed in the art.

As such, there is a need in the art for chemically modified cyclodextrin polysulfates, in particular β-cyclodextrin polysulfates that are suitable for the aforementioned purposes and characterized in having a reduced induction of platelet aggregation and vascular thrombosis in individuals afflicted with heparin- and heparin-like induced thrombocytopenia. There is also a need in the art for chemically modified cyclodextrin polysulfates, in particular β-cyclodextrin polysulfates which can be used for the aforementioned purposes but without inducing strong anti-coagulant activity. There is also a need in the art for chemically modified cyclodextrin polysulfates, in particular β-cyclodextrin polysulfates which can be used for the aforementioned purposes but without inducing platelet activation or thrombosis in the presence of heparin- and platelet factor IV-complex reactive antibodies. There is also a need in the art for chemically modified cyclodextrin polysulfates, in particular β-cyclodextrin polysulfates which can be used for the aforementioned purposes but without a heparin-like induced activation of the contact system; in particular without the heparin or heparin like-induced activation/generation of bradykinin, a potent vasoactive mediator and/or without the activation/generation of complement derived anaphylatoxins, such as C3a and C5a.

When chemically modified cyclodextrins are intended for use as biologically active agents, e.g. in the form of their polysulfates and/or salts thereof, the situation of structural variability resulting from random substitution with average degrees of substitution representative of mixtures of compounds is fewly or not admissible for regulatory and quality control reasons.

Thus, it is one problem to be addressed by the presently claimed invention to provide a synthetic route, and suitable intermediates, to directly access well-defined carboxyalkyl cyclodextrin derivatives in the form of single compounds with an assignable mass or nuclear magnetic resonance spectrum representative of their individual structural formulae.

It is another problem to be addressed by the presently claimed invention to provide such single compounds wherein preferably two carboxyalkyl moieties are located each at carbon 6 of a glucopyranose unit, more preferably at carbon 6 of glucopyranose units A and D of the alpha and beta cyclodextrin core.

It is another problem to be addressed by the presently claimed invention to provide a synthetic way of access to these single compounds in a minimal number of process steps and by avoiding unnecessarily complicated chemical reactions or costly reagents and/or catalysts. These well-defined carboxyalkyl-modified cyclodextrin derivatives should also be easily submitted to polysulfation in an attempt to cure some of the potential side-effects of β-cyclodextrin polysulfates.

### SUMMARY OF THE INVENTION

It has been unexpectedly found that the problem addressed by the present invention can be solved in a cost-efficient manner by starting from the mono-de-O-benzylation or di-de-O-benzylation product of a perbenzylated cyclodextrin and submitting it to etherification, e.g. via Williamson ether synthesis or 1,4-addition (so-called Michael addition reaction) with a reagent containing a terminal carboxylic ester moiety or a terminal nitrile moiety. Finally the intermediates obtained from this etherification reaction may then be completely debenzylated e.g. via catalytic hydrogenation using art known procedures such as for example provided by Bistri et al., Chem. Eur. J. (2007) 13, 9759-9774 (Ref. 3 in FIG. 1), and their terminal carboxylic ester moiety or terminal nitrile moiety may optionally be converted into a terminal carboxylic acid moiety via hydrogenolysis or hydrolysis. The resulting completely debenzylated carboxyalkyl cyclodextrin derivative may then be submitted to sulfation, and optionally alkali salt formation, according to standard procedures. In each step, the synthetic procedures of the invention advantageously form single compounds rather than the random variable mixtures previously known in the art. Another advantage of the present invention is that the regioselectivity present in the starting mono-de-O-benzylation or di-de-O-benzylation product of a perbenzylated cyclodextrin, i.e. the one or two alcohol groups being located each at carbon 6 of a glucopyranose unit, more preferably at carbon 6 of glucopyranose units A and D of the cyclodextrin core, is well preserved throughout the above series of chemical modifications.

### BRIEF DESCRIPTION OF THE DRAWINGS

FIG. 1 schematically shows a synthetic route for making a fully substituted cyclodextrin derivative represented by the structural formula (A) via ω-halo-alkene (R—X) or ω-hydroxy-alkene (R—OH) addition.

FIG. 2 schematically shows the general principle of a process for making a fully substituted cyclodextrin derivative represented by the structural formula (II) via a 1,4-addition reaction.

FIG. 3 schematically shows a specific embodiment of a process for making a fully substituted cyclodextrin derivative represented by the structural formula (II) via a 1,4-addition reaction with tert-butyl acrylate.

FIG. 4 schematically shows cleaving off a tert-butyl group onto a fully substituted cyclodextrin derivative represented by the structural formula (II).

FIG. 5 schematically shows deprotection of the benzyl groups onto a fully substituted cyclodextrin derivative represented by the structural formula (II) to produce 6A,6D-di-O-(carboxyethyl)-β-cyclodextrin.

### DEFINITIONS

As used herein with respect to a substituting group, and unless otherwise stated, the term “C₁₋₆ alkyl” means straight and branched chain saturated acyclic hydrocarbon monovalent groups having from 1 to 6 carbon atoms such as, for example, methyl, ethyl, propyl, n-butyl, 1-methylethyl (isopropyl), 2-methylpropyl (isobutyl), 1,1-dimethylethyl (ter-butyl), 2-methylbutyl, n-pentyl, dimethylpropyl, n-hexyl, 2-methylpentyl, 3-methylpentyl and the like. By analogy, the term “C₁₋₄ alkyl” refers to such groups having from 1 to 4 carbon atoms, i.e. up to and including butyl isomers.

As used herein with respect to a substituting group, and unless otherwise stated, the term “C₃₋₁₁ cycloalkyl” means a mono- or polycyclic saturated hydrocarbon monovalent group having from 3 to 10 carbon atoms and optionally bearing a methyl substituent, such as for instance cyclopropyl, cyclobutyl, cyclopentyl, cyclohexyl, methylcyclohexyl, cycloheptyl, cyclooctyl and the like, or a C₇₋₁₁ polycyclic saturated hydrocarbon monovalent group having from 7 to 11 carbon atoms such as, for instance, norbornyl, isobornyl, fenchyl, trimethyltricycloheptyl, adamantyl, methyladamantyl, menthyl and the like. By analogy, the term “C₅₋₆ cycloalkyl” refers to such groups having 5 or 6 carbon atoms, e.g. cyclopentyl or cyclohexyl.

As used herein with respect to a substituting group, and unless otherwise stated, the term “aryl” designates any mono- or polycyclic aromatic monovalent hydrocarbon group having from 6 up to 30 carbon atoms such as but not limited to phenyl, naphthyl, anthracenyl, phenantracyl, fluoranthrenyl, chrysenyl, pyrenyl, biphenylyl, terphenyl, picenyl, indenyl, biphenyl, indacenyl, benzocyclobutenyl, benzocyclooctenyl and the like, including fused benzo-C₄₋₈ cycloalkyl radicals (the latter being as defined above) such as, for instance, indanyl, tetrahydronaphthyl, fluorenyl and the like, all of the said radicals being optionally substituted with one or more non-reactive substituents (e.g. methyl, ethyl, isopropyl, trifluoromethyl, trifluoromethoxy, fluoro and the like).

As used herein with respect to a substituting group, and unless otherwise stated, the terms “C₁₋₄ alkoxy”, “C₃₋₁₀ cycloalkoxy”, “aryloxy” and “C₁₋₄ alkylthio” refer to substituents wherein a carbon atom of a C₁₋₄ alkyl, respectively a C₃₋₁₀ cycloalkyl or aryl group (each of them such as defined herein), is attached to an oxygen atom or a divalent sulfur atom through a single bond such as, but not limited to, methoxy, ethoxy, propoxy, butoxy, isopropoxy, sec-butoxy, tert-butoxy, cyclopropyloxy, cyclobutyloxy, cyclopentyloxy, methylthio, ethylthio, propylthio, butylthio, phenyloxy, and the like.

As used herein with respect to a substituting group, and unless otherwise stated, the term “aryl-C₁₋₄ alkyl” refers to a C₁₋₄ alkyl group (such as defined above) onto which an aryl group (such as defined above) is bonded via a carbon atom, and wherein each of the said groups may be optionally substituted with one or more non-reactive substituents (e.g. methyl, ethyl, isopropyl, trifluoromethyl, trifluoromethoxy, fluoro and the like), such as but not limited to benzyl, 4-fluorobenzyl, 2-fluorobenzyl, 3-methylbenzyl, 4-methylbenzyl, 4-ter-butylbenzyl, phenylpropyl, 1-naphthylmethyl, 2-phenylethyl and the like.

As used herein with respect to a cyclodextrin derivative, and unless otherwise stated, the term “fully substituted’ means that no free hydroxyl group is left at any position of any glucopyranose unit; this also means that a fully substituted α-cyclodextrin derivative has 18 substituents, a fully substituted β-cyclodextrin has 21 substituents, and a fully substituted γ-cyclodextrin has 24 substituents.

As used herein and unless otherwise stated, the term “stereoisomer” refers to all possible different isomeric as well as conformational forms which the compounds of this invention may possess, in particular all possible stereochemically and conformationally isomeric forms, all diastereomers, enantiomers and/or conformers of the basic molecular structure. In as far some compounds of the present invention would exist in different tautomeric forms, all of the latter being included within the scope of the present invention.

### DETAILED DESCRIPTION OF THE INVENTION

A first aspect of this invention is to provide a fully substituted cyclodextrin derivative represented by any one of the structural formulae:

(BnO)ₘ—CD—[CH₂—O—R₃—C(═O)—OR′]ₙ (A)

(BnO)ₘ—CD—[CH₂—O—R₄—CN]ₙ (B)
wherein, in each of these structural formulae, Bn is benzyl, CD represents the cyclodextrin core, n is 1 or 2, and m+n is the total number of free hydroxyl groups of the unsubstituted cyclodextrin;
wherein:
R₃ and R₄ are each independently a divalent saturated or unsaturated C₁₋₁₀alkyl, wherein said C₁₋₁₀alkyl is optionally substituted with from 1 to 3 substituents selected from C₃₋₁₀ cycloalkoxy-C₁₋₄alkyl, aryloxy-C₁₋₄alkyl, C₁₋₄alkoxy-C₁₋₄alkyl, aryl-C₁₋₄alkoxy-C₁₋₄alkyl, aryl, aryl-C₁₋₄alkyl, carboxyl, cyano, fluoro, chloro, bromo, trifluoromethyl, ethoxy and phenyl, and R′ is selected from the group consisting of hydrogen, C₁₋₆ alkyl, C₅₋₆cycloalkyl, aryl, aryl-C₁₋₄ alkyl, C₁₋₄ alkoxy-C₁₋₄alkyl, C₁₋₄alkylthio-C₁₋₄alkyl, aryl-C₁₋₄alkyl, and C₅₋₁₁cycloalkyl; wherein each aryl is optionally substituted with from one to two substituent selected from the group consisting of C₁₋₄ alkyl, C₁₋₄ alkoxy, phenoxy, benzyl, and phenyl;

A further aspect of the present invention relates to a family of fully substituted cyclodextrin derivatives represented by any one of the structural formulae:

(BnO)ₘ—CD—[CH₂—O—CH₂—R—C(═O)—OR′]ₙ (I)

(BnO)ₘ—CD—[CH₂—O—CH═R—C(═O)—OR′]ₙ (Ia)

(BnO)ₘ—CD—[CH₂—O—CH₂—CH(R₁)—C(═O)—OR″]ₙ (II)

(BnO)ₘ—CD—[CH₂—O—CH₂—CH(R₂)—CN]ₙ (III)

wherein, in each of these structural formulae, Bn is benzyl, CD represents the cyclodextrin core, n is 1 or 2, and m+n is the total number of free hydroxyl groups of the unsubstituted cyclodextrin;
wherein in the structural formula (I) and (Ia):
R is a single bond or a saturated aliphatic chain having 1 to 4 carbon atoms, and
R′ is selected from the group consisting of hydrogen, C₁₋₆ alkyl, C₅₋₆ cycloalkyl and aryl-C₁₋₄ alkyl;
   wherein in the structural formula (II):
R₁ is selected from the group consisting of C₁₋₆ alkyl, C₃₋₁₀ cycloalkoxy-C₁₋₄ alkyl, aryloxy-C₁₋₄ alkyl, C₁₋₄ alkoxy-C₁₋₄ alkyl, aryl-C₁₋₄ alkoxy-C₁₋₄ alkyl, aryl, aryl-C₁₋₄ alkyl and cyano, and
R″ is selected from the group consisting of C₁₋₆ alkyl; C₁₋₄ alkoxy-C₁₋₄ alkyl; C₁₋₄ alkylthio-C₁₋₄ alkyl; aryl-C₁₋₄ alkyl wherein said aryl is optionally substituted with one substituent selected from the group consisting of C₁₋₄ alkyl, C₁₋₄ alkoxy, phenoxy and phenyl; aryl optionally substituted with one or two substituents selected from the group consisting of C₁₋₄ alkyl, C₁₋₄ alkoxy, phenyl and benzyl; and C₅₋₁₁ cycloalkyl;
   and wherein in the structural formula (III) R₂ is selected from the group consisting of C₁₋₆ alkyl, fluoro, chloro, bromo, trifluoromethyl, cyano, ethoxy and phenyl.

A preferred embodiment of the above listed aspects of the present invention relates to fully substituted cyclodextrin derivatives wherein n is 2. This is due to two reasons: first it is known from Pearce that the di-de-O-benzylation product of a perbenzylated cyclodextrin can be obtained in better yield and without forming side products than the corresponding mono-de-O-benzylation product; secondly it is expected that for the chemical modifications of this invention to bring substantial advantages, after polysulfation, over the cyclodextrin polysulfates of the prior art, it may be necessary to modify two glucopyranose units of the cyclodextrin core.

The number of glucopyranose units in the cyclodextrin core is not a critical parameter of the above listed aspects of the present invention. For practical and commercial availability reasons, this number should preferably be 6, 7 or 8. One particular embodiment of the above listed aspects of the present invention thus relates to fully substituted cyclodextrin derivatives as broadly defined herein-above by any one of the structural formulae (A), (B), (I), (Ia), (II) and (III), wherein CD represents a beta-cyclodextrin core, and m+n is 21.

A preferred embodiment of the above listed aspects of the present invention relates to fully substituted β-cyclodextrin derivatives as defined herein-above by any one of the structural formulae (A), (B), (I), (Ia), (II) and (III), wherein n is 2 and m is 19.

Another particular embodiment of the above listed aspects of the present invention relates to fully substituted cyclodextrin derivatives as broadly defined herein-above by any one of the structural formulae (A), (B), (I), (Ia), (II) and (III), wherein CD represents an alpha-cyclodextrin core, and m+n is 18.

A preferred embodiment of the above listed aspects of the present invention relates to fully substituted α-cyclodextrin derivatives as defined herein-above by any one of the structural formulae (A), (B), (I), (Ia) (II) and (III), wherein n is 2 and m is 16.

Another particular embodiment of the above listed aspects of the present invention relates to fully substituted cyclodextrin derivatives as broadly defined herein-above by any one of the structural formulae (A), (B), (I), (Ia), (II) and (III), wherein CD represents a gamma-cyclodextrin core, and m+n is 24.

A preferred embodiment of the above listed aspects of the present invention relates to fully substituted γ-cyclodextrin derivatives as defined herein-above by any one of the structural formulae (A), (B), (I), (Ia), (II) and (III), wherein n is 2 and m is 22.

A preferred embodiment of the above listed aspects of the present invention relates to fully substituted cyclodextrin derivatives as broadly defined by any one of the structural formulae (A), (B), (I), (Ia), (II) and (III), wherein n is 2 and both non-benzyl substituents are located each at carbon 6 of a glucopyranose unit, more preferably at carbon 6 of glucopyranose units A and D of the cyclodextrin core.

One embodiment of the above listed aspects of the present invention relates to fully substituted cyclodextrin derivatives represented by the structural formula (I) wherein R is a saturated aliphatic linear or branched chain having 2 or 3 or 4 carbon atoms.

Another embodiment of the above listed aspects of the present invention relates to fully substituted cyclodextrin derivatives (e.g. alpha, beta or gamma cyclodextrin derivatives) being represented by the structural formulae (A), (I) or (Ia) wherein R′ is benzyl, or being represented by the structural formula (II) wherein R″ is benzyl. This particular feature is advantageous because exactly the same deprotection technique can be used in a later stage for cleaving off this R′ or R″ benzyl group as well as for the other m benzyl groups present on the cyclodextrin core.

A third aspect of the present invention is a mono- or di-substituted cyclodextrin derivative represented by any one of the structural formulae:

(HO)ₘ—CD—[CH₂—O—R₃—C(═O)—OH]ₙ (C)

(HO)ₘ—CD—[CH₂—O—R₄—C(═O)—OH]ₙ (D)
wherein, in each of these structural formulae, CD represents the cyclodextrin core, n is 1 or 2,
R₃ and R₄ are each independently a divalent saturated or unsaturated C₁₋₁₀alkyl, wherein said C₁₋₁₀alkyl is optionally substituted with from 1 to 3 substituents selected from C₃₋₁₀ cycloalkoxy-C₁₋₄alkyl, aryloxy-C₁₋₄alkyl, C₁₋₄alkoxy-C₁₋₄alkyl, aryl-C₁₋₄alkoxy-C₁₋₄alkyl, aryl, aryl-C₁₋₄alkyl, cyano, carboxyl, fluoro, chloro, bromo, trifluoromethyl, ethoxy and phenyl. In a particular embodiment the mono- or di-substituted cyclodextrin derivative of formula (C) is derived from the fully substituted cyclodextrin derivative represented by formula (A); and the mono- or di-substituted cyclodextrin derivative of formula (D) is derived from the fully substituted cyclodextrin derivative represented by formula (B); and wherein R₃ and R₄ respectively correspond to the R₃ and R₄ definition used in said cyclodextrin derivative of formula (A) and (B).

A fourth aspect of the present invention relates to a family of mono- or di-substituted cyclodextrin derivatives represented by any one of the structural formulae:

(HO)ₘ—CD—[CH₂—O—CH₂—R—C(═O)—OH]ₙ (IV)

(HO)ₘ—CD—[CH₂—O—CH₂—CH(R₁)—C(═O)—OH]ₙ (V)

(HO)ₘ—CD—[CH₂—O—CH₂—CH(R₂)—C(═O)—OH]ₙ (VI)

wherein, in each of these structural formulae, CD represents the cyclodextrin core, and n is 1 or 2,
wherein in the structural formula (IV) R is a saturated aliphatic branched chain having 2 to 4 carbon atoms,
wherein in the structural formula (V) R₁ is selected from the group consisting of C₁₋₆ alkyl, C₃₋₁₀ cycloalkoxy-C₁₋₄ alkyl, aryloxy-C₁₋₄ alkyl, C₁₋₄ alkoxy-C₁₋₄ alkyl, aryl-C₁₋₄ alkoxy-C₁₋₄ alkyl, aryl, aryl-C₁₋₄ alkyl, cyano and carboxyl, and
wherein in the structural formula (VI) R₂ is selected from the group consisting of C₁₋₆ alkyl, fluoro, chloro, bromo, trifluoromethyl, cyano, carboxyl, ethoxy and phenyl.

A preferred embodiment of these third and fourth aspects of the present invention relates to mono- or di-substituted cyclodextrin derivatives as defined herein-above by any one of the structural formulae (C), (D), (IV), (V) and (VI), wherein n is 2. The reason is the expectation that for the chemical modifications of this invention to bring substantial advantages, after polysulfation, over the cyclodextrin polysulfates of the prior art, it may be necessary to modify two glucopyranose units of the cyclodextrin core.

The number of glucopyranose units in the cyclodextrin core is not a critical parameter of this second aspect of the present invention. For practical and commercial availability reasons, this number should preferably be 6, 7 or 8. One particular embodiment of these third and fourth aspects of the present invention thus relates to mono- or di-substituted cyclodextrin derivatives as broadly defined herein-above by any one of the structural formulae (C), (D), (IV), (V) and (VI), wherein CD represents a beta-cyclodextrin core, and m+n is 21.

A preferred embodiment of these third and fourth aspects of the present invention relates to di-substituted β-cyclodextrin derivatives wherein n is 2 and m is 19.

Another particular embodiment of these third and fourth aspects of the present invention relates to mono- or di-substituted cyclodextrin derivatives as broadly defined herein-above by any one of the structural formulae (C), (D), (IV), (IVa), (V) and (VI), wherein CD represents an alpha-cyclodextrin core, and m+n is 18.

A preferred embodiment of these third and fourth aspects of the present invention relates to di-substituted α-cyclodextrin derivatives as broadly defined herein-above by any one of the structural formulae (C), (D), (IV), (V) and (VI), wherein n is 2 and m is 16.

Another particular embodiment of these third and fourth aspects of the present invention relates to mono- or di-substituted cyclodextrin derivatives as broadly defined herein-above by any one of the structural formulae (C), (D), (IV), (V) and (VI), wherein CD represents a gamma-cyclodextrin core, and m+n is 24.

A preferred embodiment of these third and fourth aspects of the present invention relates to di-substituted γ-cyclodextrin derivatives as broadly defined herein-above by any one of the structural formulae (C), (D), (IV), (V) and (VI), wherein n is 2 and m is 22.

A preferred embodiment of these third and fourth aspects of the present invention relates to di-substituted cyclodextrin derivatives (n is 2) wherein both substituents are located each at carbon 6 of a glucopyranose unit, more preferably at carbon 6 of glucopyranose units A and D of the cyclodextrin core.

A fifth aspect of the present invention relates to a_process for making a fully substituted cyclodextrin derivative being represented by any one of the structural formulae (A), (B), (I), (Ia), (II) and (III), comprising the steps of:
(a) providing a primary alcohol or diol being the mono-de-O-benzylation or di-de-O-benzylation product of a perbenzylated cyclodextrin,
(b) submitting said primary alcohol or diol to an etherification reaction, and
(c) recovering said fully substituted cyclodextrin derivative represented by any one of the structural formulae (A), (B), (I), (Ia), (II) and (III).

Any etherification method suitable for directly or indirectly replacing each primary alcohol group(s) of the mono- or di-de-O-benzylation product provided in step (a) with:
a group having the structural formula O—R₃—C(═O)—OR′ to achieve a cyclodextrin derivative represented by the structural formula (A);
a group having the structural formula O—CH₂—R—C(═O)—OR′ to achieve a cyclodextrin derivative represented by the structural formula (I);
a group having the structural formula O—CH═R—C(═O)—OR′ to achieve a cyclodextrin derivative represented by the structural formula (Ia);
a group having the structural formula O—CH₂—CH(R₁)—C(═O)—OR″ to achieve a cyclodextrin derivative represented by the structural formula (II);
a group having the structural formula O—R₄—CN to achieve a cyclodextrin derivative represented by the structural formula (B); or
a group having the structural formula O—CH₂—CH(R₂)—CN to achieve a cyclodextrin derivative represented by the structural formula (III)
   may be used in step (b) of this process of the invention.

Therefore one embodiment of this fifth aspect of the present invention relates to a process wherein the fully substituted cyclodextrin derivative to be produced is represented by the structural formula (A) and wherein the etherification reaction of step (b) proceeds via a Williamson ether synthesis by reacting said primary alcohol or diol with an ω-halo carboxylic acid ester or an ω-halo carboxylic acid represented by the structural formula X—R₃—C(═O)—OR′ wherein R₃ and R′ are as broadly defined in the structural formula (A), and wherein X is chloro, bromo or iodo. According to this embodiment, a group having the structural formula O—R₃—C(═O)—OR′ directly replaces each primary alcohol group(s) of the product provided in step (a).

Therefore one embodiment of this fifth aspect of the present invention relates to a process wherein the fully substituted cyclodextrin derivative to be produced is represented by the structural formula (I) and wherein the etherification reaction of step (b) proceeds via a Williamson ether synthesis by reacting said primary alcohol or diol with an ω-halo carboxylic acid ester or an ω-halo carboxylic acid represented by the structural formula X—CH₂—R—C(═O)—OR′ wherein R and R′ are as broadly defined in the structural formula (I), and wherein X is chloro, bromo or iodo. According to this embodiment, a group having the structural formula O—CH₂—R—C(═O)—OR′ directly replaces each primary alcohol group(s) of the product provided in step (a). In this embodiment, X is preferably bromo or iodo. When X is chloro, it may be useful to promote reactivity of the ω-chloro carboxylic acid ester or ω-chloro carboxylic acid by adding a catalytic amount of a soluble iodide salt capable of undergoing halide exchange with the chloride to yield the much more reactive iodide.

Therefore another embodiment of this fifth aspect of the present invention relates to a process wherein the fully substituted cyclodextrin derivative to be produced is represented by the structural formula (Ia) and wherein the etherification reaction of step (b) proceeds via a Williamson ether synthesis by reacting said primary alcohol or diol with an ω-halo carboxylic acid ester or an ω-halo carboxylic acid represented by the structural formula X—CH═R—C(═O)—OR′ wherein R and R′ are as broadly defined in the structural formula (Ia), and wherein X is chloro, bromo or iodo. According to this embodiment, a group having the structural formula O—CH═R—C(═O)—OR′ directly replaces each primary alcohol group(s) of the product provided in step (a). In this embodiment, X is preferably bromo or iodo. When X is chloro, it may be useful to promote reactivity of the ω-chloro carboxylic acid ester or ω-chloro carboxylic acid by adding a catalytic amount of a soluble iodide salt capable of undergoing halide exchange with the chloride to yield the much more reactive iodide. Particular examples of the aforementioned general synthesis are provided in examples 2 (addition of acrylester) and 3 (addition of propiolate ester) hereinafter.

According to a particular embodiment of this process, in order to provide a fully substituted cyclodextrin derivative represented by the structural formula (I) or (Ia) wherein R is saturated aliphatic linear chain, the omega-halo carboxylic acid ester may be selected from the group consisting of methyl chloroacetate, methyl bromoacetate, ethyl bromoacetate, ethyl chloroacetate, propyl chloroacetate, n-propyl bromoacetate, butyl chloroacetate, tert-butyl bromoacetate, hexyl chloroacetate, hexyl bromoacetate, cyclopentyl chloroacetate, cyclopentyl bromoacetate, cyclohexyl chloroacetate, cyclohexyl bromoacetate, benzyl chloroacetate, benzyl bromoacetate, 2-phenylethyl bromoacetate, 2-phenylethyl chloroacetate, 3-phenylpropyl 2-chloroacetate, methyl 3-chloropropionate, methyl 3-bromopropionate, ethyl 3-chloropropionate, ethyl 3-bromopropionate, propyl 3-bromopropionate, butyl 3-chloropropionate, cyclohexyl 3-bromopropionate, cyclohexyl 3-chloropropionate, benzyl 3-chloropropionate, ethyl iodoacetate, tert-butyl iodoacetate, methyl 3-iodopropionate, ethyl 3-iodopropionate, tert-butyl 3-iodopropionate, methyl 4-iodobutyrate, ethyl 4-iodobutyrate, tert-butyl 4-iodobutyrate, ethyl 5-iodovalerate, methyl 6-iodohexanoate, ethyl 6-iodohexanoate, tert-butyl 6-iodohexanoate, methyl 4-chlorobutyrate, ethyl 4-chlorobutyrate, propyl 4-chlorobutyrate, isopropyl 4-chlorobutyrate, butyl 4-chlorobutyrate, cyclohexyl 4-chlorobutyrate, benzyl 4-chlorobutyrate, methyl 4-bromobutyrate, ethyl 4-bromobutyrate, propyl 4-bromobutyrate, isopropyl 4-bromobutyrate, butyl 4-bromobutyrate, cyclohexyl 4-bromobutyrate, benzyl 4-bromobutyrate, methyl 5-chlorovalerate, ethyl 5-chlorovalerate, propyl 5-chlorovalerate, isopropyl 5-chlorovalerate, butyl 5-chlorovalerate, cyclohexyl 5-chlorovalerate, benzyl 5-chlorovalerate, methyl 5-bromovalerate, ethyl 5-bromovalerate, propyl 5-bromovalerate, isopropyl 5-bromovalerate, butyl 5-bromovalerate, cyclohexyl 5-bromovalerate, benzyl 5-bromovalerate, methyl 6-chlorohexanoate, ethyl 6-chlorohexanoate, propyl 6-chlorohexanoate, isopropyl 6-chlorohexanoate, butyl 6-chlorohexanoate, cyclohexyl 6-chlorohexanoate, benzyl 6-chlorohexanoate, methyl 6-bromohexanoate, ethyl 6-bromohexanoate, propyl 6-bromohexanoate, isopropyl 6-bromohexanoate, butyl 6-bromohexanoate, cyclohexyl 6-bromohexanoate, and benzyl 6-bromohexanoate.

According to another particular embodiment of this process, in order to provide a fully substituted cyclodextrin derivative represented by the structural formula (I) wherein R is saturated aliphatic branched chain, the omega-halo carboxylic acid ester may be selected from the group consisting of methyl (R)-(+)-3-bromo-2-methylpropionate, methyl 4-chloro-2-methylbutyrate, ethyl 4-bromo-2-methylbutyrate, ethyl 5-bromo-3-methylvalerate, (R)-5-bromo-4-methylvalerate, and methyl 2,2-dimethyl-β-chloropropionate.

According to another particular embodiment of this process, in order to provide a fully substituted cyclodextrin derivative represented by the structural formula (I) wherein R is saturated aliphatic linear chain, the omega-halo carboxylic acid may be selected from the group consisting of 2-chloroacetic acid, 2-bromoacetic acid, 2-iodoacetic acid, 3-chloropropionic acid, 3-bromopropionic acid, 3-iodopropionic acid, 4-chlorobutyric acid, 4-bromobutyric acid, 4-iodobutyric acid, 5-chlorovaleric acid, 5-bromovaleric acid, and 5-iodovaleric acid.

According to another particular embodiment of this process, in order to provide a fully substituted cyclodextrin derivative represented by the structural formula (I) wherein R is saturated aliphatic branched chain, the omega-halo carboxylic acid may for instance be 3-chloro-2-methylpropionic acid or 4-chloro-3-methylbutyric acid.

As is well known to the skilled person, a typical Williamson reaction may be conducted at relatively moderate temperatures (e.g. within a range from about 50° C. to 100° C.) and may be completed upon about 1 to 8 hours, depending upon the choice of the halogen, the chain length and the accessibility of the primary alcohol group. Typical Williamson reactions may be conducted in a solvent such as, but not limited to, acetonitrile or N,N-dimethylformamide. Protic solvents and apolar solvents should preferably be avoided in order to reduce the risk of significantly slowing down the reaction rate.

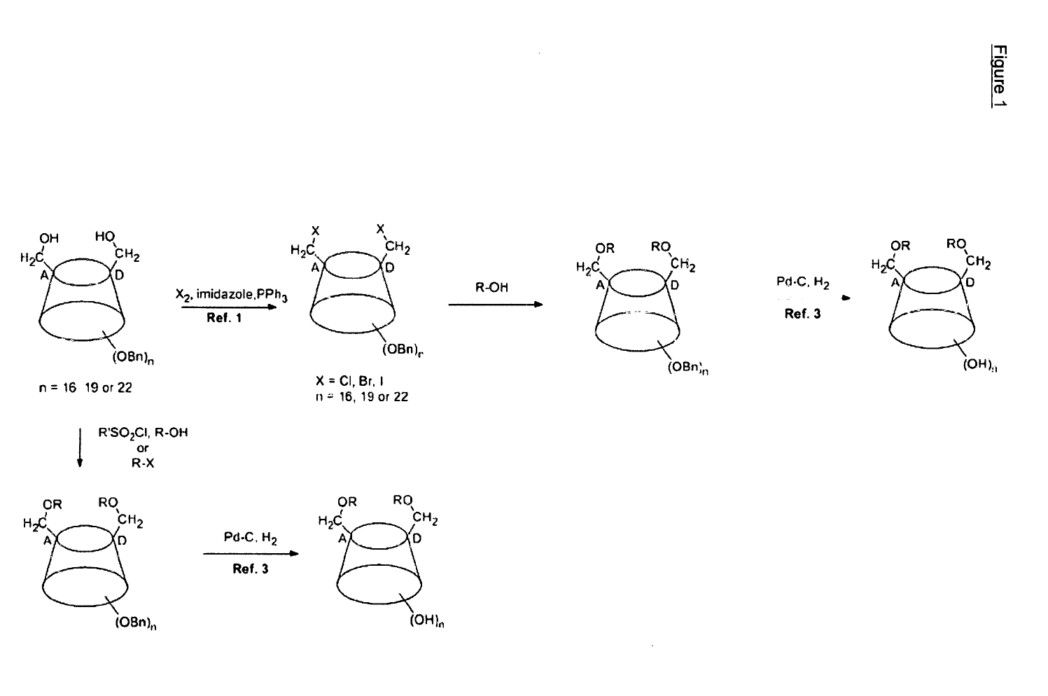

A first alternative synthetic route (i) as represented in FIG. 1 for producing a fully substituted cyclodextrin derivative represented by the structural formula (A) wherein R is _R₃—C(═O)—OR′ as defined for the compounds of formula (A) via a Williamson ether synthesis is by the following sequence of steps:
first reacting the product provided in step (a) with either an ω-halo-alkene being represented by the structural formula H₂C═CH—(CH₂)ₚ—X wherein X is chloro, bromo or iodo, and wherein p is from 0 to 4; or with an ω-hydroxy-alkene being represented by the structural formula H₂C═CH—(CH₂)ₚ—OH wherein p is from 0 to 4; and
then oxidizing the terminal alkene into the corresponding carboxylic acid.

Representative examples of ω-halo-alkenes required in the first step of this first alternative synthetic route include, but are not limited to, vinyl bromide (p=0), allyl chloride, allyl bromide, allyl iodide (p=1), 4-bromo-1-butene (p=2), 5-bromo-1-pentene (p=3) and 6-bromo-1-hexene (p=4).

Representative examples of ω-hydroxy-alkenes required in the second step of this second alternative synthetic route include, but are not limited to, vinyl alcohol (p=0), allyl alcohol (p=1), 3-buten-1-ol (p=2), 4-penten-1-ol (p=3) and 5-hexen-1-ol (p=4).

The second oxidizing step of this first alternative synthetic route may be performed according to known oxidizing methods such as, but not limited to, the presence of a transition metal catalyst, for instance a compound of a transition of group VIII of the Classification of Elements like ruthenium trichloride, or osmium oxide in combination with sodium iodate. Practical details of such a method may be found in Buskas et al in J. Org. Chem. (2000) 65:958-963, the content of which is incorporated by reference.

A second alternative synthetic route (ii) as represented in FIG. 1 for producing a fully substituted cyclodextrin derivative represented by the structural formula (A) wherein R is _R₃—C(═O)—OR′ as defined for the compounds of formula (A) via a Williamson ether synthesis is by the following sequence of steps:
first converting the product provided in step (a) into the corresponding mono- or di-halogenide; in particular mono- or di-iodide;
then reacting said mono- or di-halogenide with an ω-hydroxy-alkene being represented by the structural formula H₂C═CH—(CH₂)ₚ—OH wherein p is from 0 to 4; and
finally oxidizing the terminal alkene into the corresponding carboxylic acid.

The first step of this second alternative synthetic route may be performed according to the methodology of Sato et al. (Ref. 1—cited supra), i.e. reacting the product provided in step (a) with iodine in a suitable solvent such as toluene and in the presence of a catalytic system such as, but not limited to, triphenylphosphine and imidazole.

Representative examples of ω-hydroxy-alkenes required in the second step of this second alternative synthetic route include, but are not limited to, vinyl alcohol (p=0), allyl alcohol (p=1), 3-buten-1-ol (p=2), 4-penten-1-ol (p=3) and 5-hexen-1-ol (p=4).

The final oxidizing step of this second alternative synthetic route may be performed according to known oxidizing methods such as, but not limited to, the presence of a transition metal catalyst, for instance a compound of a transition of group VIII of the Classification of Elements like ruthenium trichloride, or osmium oxide in combination with sodium iodate. Practical details of such a method may be found in Buskas et al in J. Org. Chem. (2000) 65:958-963, the content of which is incorporated by reference.

The fully substituted cyclodextrin derivatives represented by the structural formula (A) obtained from this etherification reaction may then be completely debenzylated e.g. via catalytic hydrogenation using art known procedures such as for example provided by Bistri et al., Chem. Eur. J. (2007) 13, 9759-9774 (Ref. 3 in FIG. 1), to yield the mono- or di-substituted cyclodextrin derivative represented by formula (C).

In these two alternative synthetic routes, practical considerations about the reaction temperature, the reaction time and the choice of solvent are the same as outlined hereinabove in respect of Williamson reactions. A particular example of the ether synthesis according to these alternative routes is provided in Example 1 hereinafter, in the synthesis of 6A,6D-di-O-(ethylenecarboxylic acid)-β-cyclodextrin.

Another embodiment of the process of the present invention relates to a process for making fully substituted cyclodextrin derivatives represented by the structural formula (II) and wherein the etherification reaction of step (b) proceeds via a 1,4-addition reaction between said primary alcohol or diol and an acrylic acid ester or an α-substituted acrylic acid ester.

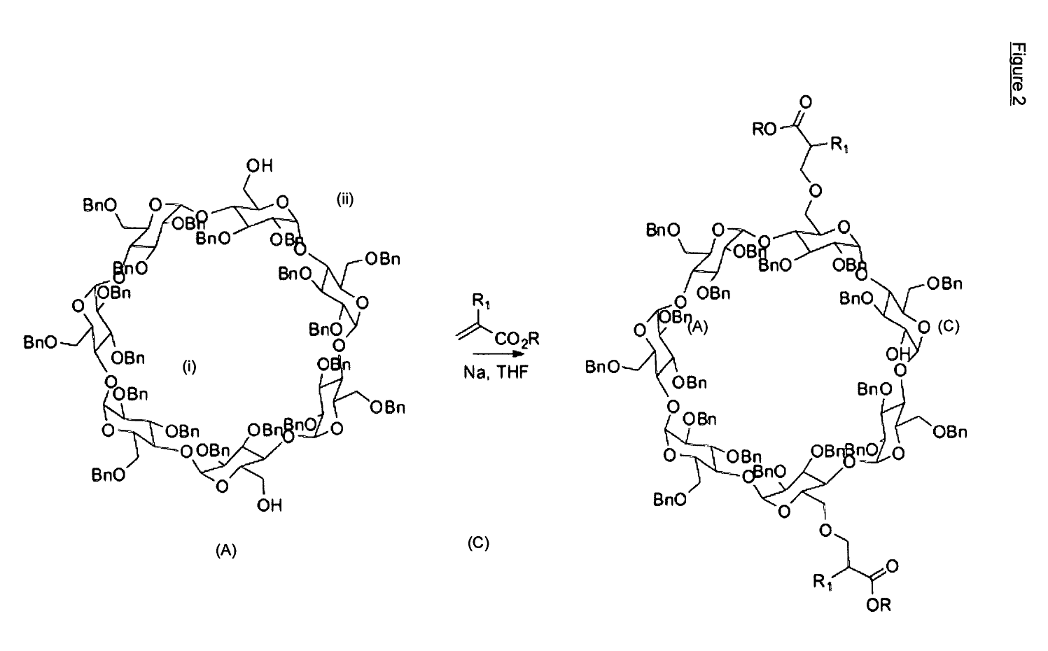

Such a process is schematically illustrated in FIG. 2 in respect of a β-cyclodextrin. Although not shown in this figure this process is applicable to α-cyclodextrins and γ-cyclodextrins as well.

The choice of the acrylic acid ester or the α-substituted acrylic acid ester is not a critical parameter of this process of the present invention. Depending upon the desired type of R₁ and R″, said acrylic acid ester or α-substituted acrylic acid ester may be selected from the group consisting of isopropyl acrylate, isobutyl acrylate, tert-butyl acrylate, benzyl acrylate, 2-phenylethyl acrylate, 3-phenylpropyl acrylate, o-methylbenzyl acrylate, p-methylbenzyl acrylate, o-methoxybenzyl acrylate, p-methoxybenzyl acrylate, p-ethoxybenzyl acrylate, p-n-butylbenzyl acrylate, p-phenoxybenzyl acrylate, p-phenylbenzyl acrylate, phenyl acrylate, p-methylphenyl acrylate, 3,5-dimethylphenyl acrylate, 2,6-diisopropylphenyl acrylate, p-methoxyphenyl acrylate, p-ethoxyphenyl acrylate, biphenylacrylate, p-benzylphenyl acrylate, cyclopentyl acrylate, cyclohexyl acrylate, cycloheptyl acrylate, cyclooctyl acrylate, isobornyl acrylate, 1-adamantyl acrylate, 2-methyl-2-adamantyl acrylate, menthyl acrylate (including all enantiomeric forms thereof), 2-norbornyl acrylate, 2-phenoxyethyl acrylate, isopropyl methacrylate, isobutyl methacrylate, tert-butyl methacrylate, benzyl methacrylate, 2-phenylethyl methacrylate, 3-phenylpropyl methacrylate, o-methylbenzyl methacrylate, p-methylbenzyl methacrylate, o-methoxybenzyl methacrylate, p-methoxybenzyl methacrylate, p-ethoxybenzyl methacrylate, p-n-butylbenzyl methacrylate, p-phenoxybenzyl methacrylate, p-phenylbenzyl methacrylate, phenyl methacrylate, p-methylphenyl methacrylate, 3,5-dimethylphenyl methacrylate, 2,6-diisopropylphenyl methacrylate, p-methoxyphenyl methacrylate, p-ethoxyphenyl methacrylate, biphenyl methacrylate, p-benzylphenyl methacrylate, cyclopentyl methacrylate, cyclohexyl methacrylate, cycloheptyl methacrylate, cyclooctyl methacrylate, isobornyl methacrylate, 1-adamantyl methacrylate, 2-methyl-2-adamantyl methacrylate, menthyl methacrylate (including all enantiomeric forms thereof), 2-norbornyl methacrylate, 2-phenoxyethyl methacrylate, 1-ethoxyethyl acrylate, 1-methoxyethyl acrylate, 1-isopropoxyethyl acrylate, 1-isobutoxyethyl acrylate, 1-(tert-butoxy)ethyl acrylate, 1-ethoxymethyl acrylate, 1-methoxymethyl acrylate, 1-isopropoxymethyl acrylate, 1-butoxymethyl acrylate, 1-(tert-butoxy)methyl acrylate, 1-ethylthioethyl acrylate, 1-methylthioethyl acrylate, 1-ethylthiomethyl acrylate, 1-isopropylthioethyl acrylate, 1-butylthioethyl acrylate, 1-(tert-butylthioethyl acrylate, 1-isopropylthiomethyl acrylate, 1-butylthiomethyl acrylate, 1-(tert-butylthiomethyl acrylate, 1-ethoxyethyl methacrylate, 1-methoxyethyl methacrylate, 1-isopropoxyethyl methacrylate, 1-isobutoxyethyl methacrylate, 1-(tert-butoxy)ethyl methacrylate, 1-ethoxymethyl methacrylate, 1-methoxymethyl methacrylate, 1-isopropoxymethyl methacrylate, 1-butoxymethyl methacrylate, 1-(tert-butoxy)methyl methacrylate, 1-ethylthioethyl methacrylate, 1-methylthioethyl methacrylate, 1-ethylthiomethyl methacrylate, 1-isopropylthioethyl methacrylate, 1-butylthioethyl methacrylate, 1-(tert-butylthioethyl methacrylate, 1-isopropylthiomethyl methacrylate, 1-butylthiomethyl methacrylate, 1-(tert-butylthiomethyl methacrylate.

Although the α-substituent of said acrylic acid ester is preferably methyl, it may also be, following the teachings of Uno et al in enantiomer (2000) 5:29-36, Chirality (1998) 10:711-716 and J. Polym. Sci A (1997) 35:721-726, one of the following:
C₃₋₁₀ cycloalkoxy-C₁₋₄ alkyl such as, but not limited to, menthoxymethyl,
arylC₁₋₄ alkoxy-C₁₋₄ alkyl such as, but not limited to, (1-phenyl-ethoxy)methyl, and
aryloxy-C₁₋₄ alkyl, C₁₋₄ alkoxy-C₁₋₄ alkyl and arylC₁₋₄ alkoxy-C₁₋₄ alkyl such as, but not limited to, phenoxymethyl, methoxymethyl, benzyloxymethyl and tert-butoxymethyl.

Working embodiments of an 1-4 addition reaction involving an acrylate include conditions (temperature, solvent type, catalyst, reaction time, etc. . . . ) which are well known to the skilled person and are illustrated in the following examples. For instance tetrahydrofuran is a suitable solvent, among others, to carry out this reaction.

Another embodiment of the aspect of the present invention relates to a process for making fully substituted cyclodextrin derivatives represented by the structural formula (III) and wherein the etherification reaction of step (b) proceeds via a 1,4-addition reaction between said primary alcohol or diol and acrylonitrile or an α-substituted acrylonitrile.

In a specific embodiment of this 1-4 addition reaction of the present invention, said α-substituted acrylonitrile may be selected from the group consisting of methacrylonitrile, 2-ethylacrylonitrile, 2-fluoro acrylonitrile, 2-chloroacrylonitrile, 2-bromoacrylonitrile, 2n-propylacrylonitrile, 2-isopropylacrylonitrile, 2-neopentylacrylonitrile, 2n-butylacrylonitrile, 2n-hexyl acrylonitrile, 2-trifluoromethylacrylonitrile, 2-ethoxyacrylonitrile and 2-phenylacrylonitrile. A particular example of the ether synthesis according to this alternative routes is provided in Example 4 hereinafter.

A sixth aspect of the present invention relates to a process for making a mono- or di-substituted cyclodextrin derivative being represented by any one of the structural formulae (A), (B), (IV), (V) and (VI), comprising the step of performing complete debenzylation of a fully substituted cyclodextrin derivative represented by one of the structural formulae (A), (B), (I), (Ia), (II) and (III) via catalytic hydrogenation. Working embodiments of this catalytic hydrogenation conditions include temperature ranges, catalyst, solvent, etc. . . . well known to the skilled person. A preferred catalyst is palladium-carbon.

Another embodiment of this sixth aspect of the present invention relates to a process for making a mono- or di-substituted cyclodextrin derivative being represented by any one of the structural formulae (C), (D), (IV), (V) and (VI) further comprising, before or after the complete debenzylation step, a hydrolysis step for converting any remaining carboxylic ester moiety and/or nitrile moiety into a carboxylic acid moiety. Working conditions for this further step are well known to the skilled person.

The reaction of a mono- or di-substituted cyclodextrin derivative being represented by any one of the structural formulae (C), (D), (IV), (V) and (VI), with a sulfating agent is desirable from the point of view of producing well-defined biologically active agents which may solve some of the problems (as outlined in the Background of the Invention) of beta-cyclodextrin sulfates. This reaction may suitably be carried out under standard sulfation conditions, e.g. in a suitable solvent. As a sulfating agent, may suitably be used, for example, a sulphur trioxide complex, such as sulphur trioxide-pyridine complex, sulphur trioxide-trialkylamine complex, sulphur trioxide-dioxane complex, sulphur trioxide dimethylformamide complex and the like, anhydrous sulphuric acid, concentrated sulphuric acid, chlorosulfonic acid, and so on.

The amount of the sulfating agent to be used may be in excess of the amount of the mono- or di-substituted cyclodextrin derivative according to the second aspect of this invention. For example, where a sulphur trioxide-pyridine complex or a sulphur trioxide-trialkylamine complex is used as a sulfating agent, the amount thereof to be used may preferably be from 1 to 10 molar equivalents, especially from 2 to 5 molar equivalents, relatively to the amount of hydroxyl-groups present within the mono- or di-substituted cyclodextrin derivative.

As a solvent for the sulfation reaction, there may preferably be used for example a tertiary amine such as, but not limited to, pyridine, picoline, lutidine, or alternatively N,N-dimethylformamide, N-methyl-2-pyrrolidinone (NMP), N,N′-dimethylethyleneurea (DMEU), N,N′-dimethylpropyleneurea (DMPU), benzene, toluene, xylene, water, alcohols or a mixture of these solvents in any suitable proportions, liquid sulphur dioxide and so on. The sulfation reaction can be carried out under cooling or heating conditions and may preferably be carried out under heating, preferably at a temperature within a range from about 40° C. to about 100° C.

More specifically, and depending upon the sulfation reaction conditions (such as, but not limited to, temperature, reaction time, etc), the mono- or di-substituted cyclodextrin derivative polysulfate compounds may be obtained as a mixture of sulfates, e.g. a mono- or di-substituted β-cyclodextrin polysulfate in which either 16 SO₃H groups or 17 SO₃H groups or 18 SO₃H groups are present. However the precise definition of the mono- or di-substituted cyclodextrin derivative, with respect to the location of the carboxyalkyl substituent(s) onto the glucopyranose unit, is preserved.

After completion of the sulfation reaction, the reaction product can be isolated and purified or can be used as such for further conversion into a pharmaceutically acceptable salt. For example, the crude product obtained from the sulfation reaction can be treated with an alkali metal compound such as, but not limited to, sodium acetate to produce the corresponding alkali metal, e.g. sodium salt. If desired to achieve a pharmaceutical grade with high purity, the latter may then be submitted to further purification by washing with methanol and/or treatment with activated charcoal.

The following examples are given by way of illustration only, and by no way should be interpreted to narrowly construct the scope of protection of the present invention.

### Example 1

The synthetic procedure of this example follows the principles schematically shown in FIG. 1, and more precisely the details shown in the reaction scheme 1 hereinbelow.

Starting Compound (1):

The starting material 1 (obtained in 2 steps from β-cyclodextrin) was allylated using allyl bromide in presence of sodium hydride and DMF as solvent employing a known procedure, as described in (a) Fenger et al. Org. Biomol. Chem. (2009) 7, 933-943.

Synthesis of Compound (2):

To a solution of compound 1 (1.0 g, 0.35 mmol) in DMF (10 mL) was added NaH (60% dispersion in mineral oil, 71 mg, 1.75 mmol) at 0° C. and the mixture was stirred for 30 min. Allyl bromide (185 μL, 2.11 mmol) was added, and the reaction mixture was stirred overnight at room temperature. Volatile materials were removed under reduced pressure. The residue was partitioned between ethyl acetate and water. The organic layer was separated, dried over anhydrous MgSO₄, and filtered. The residue after evaporation of filtrate was purified by column chromatography (R_{f}−0.7, 1:2 ethyl acetate-hexanes) to afford 2 (1.0 g, 97%) as a white foam.

¹H NMR (CDCl₃, 300 MHz) δ 7.34-7.26 (m, 28H), 7.26-7.18 (m, 44H), 7.18-7.09 (m, 23H), 5.87-5.70 (m, 2H), 5.32-5.02 (m, 18H), 4.89-4.74 (m, 7H), 4.64-4.40 (m, 24H), 4.16-3.83 (m, 32H), 3.71-3.46 (m, 14H).

ESI-HRMS analysis:

| For C₁₈₁H₁₉₂O₃₅ | Calculated | Observed |
|---|---|---|
| [M + K]⁺ | 2965.2915, 2966.2948, | 2966.0190, 2965.0151, |
| | 2967.2982, 2964.2881 | 2967.0225, 2968.0168, |
| | | 2964.0098 |
| [M + Na]⁺ | 2949.3175, 2950.3209, | 2950.0417, 2949.0396, |
| | 2951.3243, 2948.3142 | 2951.0469, 2948.0518 |
| [M + NH₄]⁺ | 2944.3621, 2945.3655, | 2945.0906, 2944.080, |
| | 2946.3689, 2943.3588 | 2946.101, 2943.0798 |

Synthesis of Compound (3):

A solution of 9-BBN (0.5M in THF, 3.4 mL) was added to a stirring mixture of compound 2 (200 mg, 0.068 mmol) in THF (2.0 mL) at 0° C. After stirring overnight, a cold mixture of 3N NaOH (0.8 mL)/aq. H₂O₂ (35%, 2.1 mL) was added slowly at 0° C. and stirring was continued overnight at room temperature. The reaction was quenched by addition of saturated aq. NH₄Cl and the mixture was extracted with ethyl acetate. The organic layer was dried over anhydrous MgSO₄ and the residue obtained after evaporation was purified by column chromatography (R_{f}−0.3, 1:2 ethyl acetate-hexanes) to afford 3 (120 mg, 59%) as a white foam.

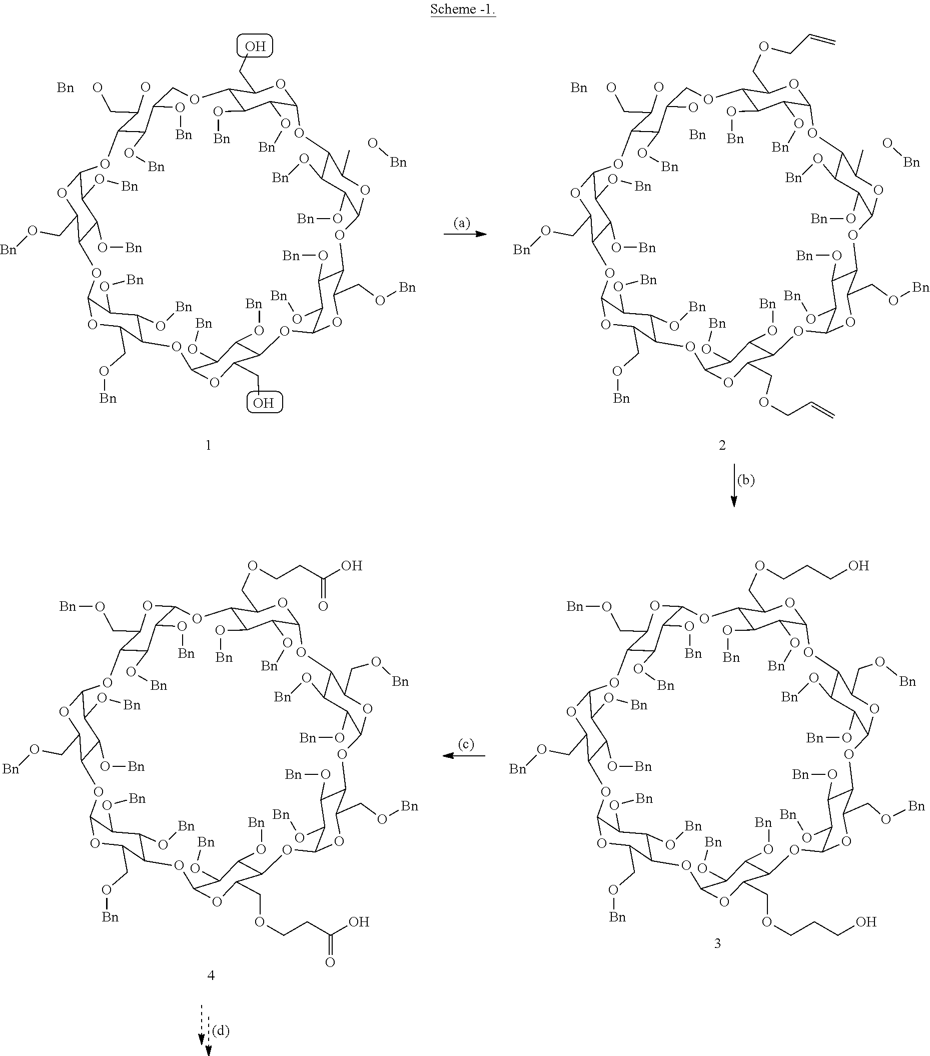

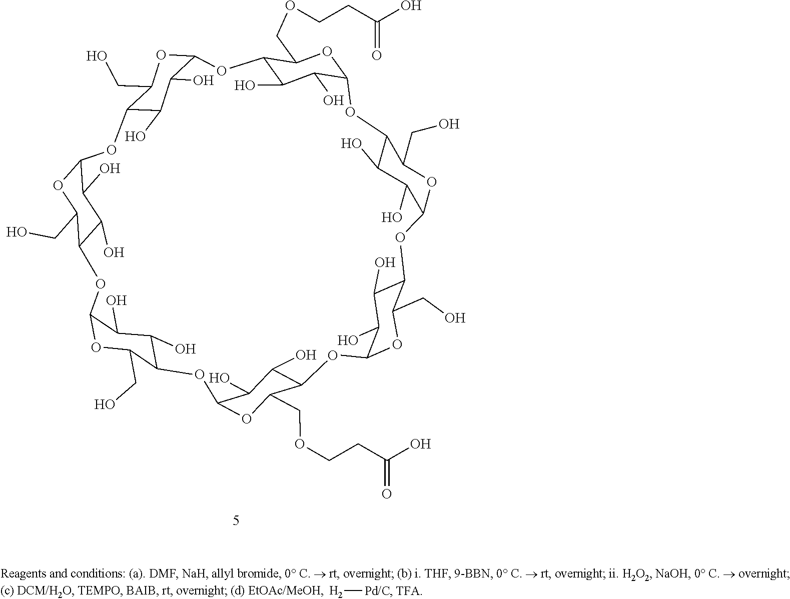

¹H NMR (CDCl₃, 300 MHz) δ 7.16 (app-t, J=2.33 Hz, 26H), 7.13-6.95 (m, 69H), 5.1-4.84 (m, 13H), 4.77-4.57 (m, 7H), 4.47-4.20 (m, 24H), 4.0-3.66 (m, 28H), 3.60-3.16 (m, 23H), 2.17 (brs, 2H), 1.55 (app-sept, J=5.33 Hz, 4H).

ESI-HRMS analysis:

| For C₁₈₁H₁₉₆O₃₇ | Calculated | Observed |
|---|---|---|
| [M + K]⁺ | 3001.3126, 3002.3160, | 3002.0750, 3001.0781, |
| | 3003.3193, 3000.3093, | 3003.0808, 3000.0627, |
| | 3004.3227 | 3004.0818 |
| [M + Na]⁺ | 2985.3387, 2986.3420, | 2985.0945, 2986.0950, |
| | 2987.3454, 2984.3353, | 2987.1094, 2984.0938, |
| | 2988.3487 | 2988.1060 |

Synthesis of Compound (4):

A biphasic mixture of compound 3 (120 mg, 0.04 mmol) in dichloromethane-water (3.0:1.5 mL) was sequentially treated with iodobenzene diacetate (BAIB, 158 mg, 0.48 mmol) and 2,2,6,6-Tetramethylpiperidine-1-oxyl (TEMPO, 6 mg, 0.04 mmol) at room temperature. The reaction was allowed to proceed overnight and stopped by the addition of aq. Na₂S₂O₃. After acidification with dil. HCl, the product was extracted in dichloromethane, dried over anhydrous MgSO₄ and filtered. The residue obtained after evaporation of the solvent was purified by column chromatography (R_{f}−0.3, 2:1 ethyl acetate-hexanes) to afford 4 (37 mg, 30%) as colorless solid (Note 3).

¹H NMR (CDCl₃, 300 MHz) δ 7.30-7.13 (m, 31H), 7.12-6.88 (m, 64H), 5.16 (d, J=3.46 Hz, 1H), 5.13-5.00 (m, 6H), 4.95 (app-dd, J=9.8, 3.8 Hz, 3H), 4.87 (d, J=3.1 Hz, 1H), 4.80-4.55 (m, 9H), 4.55-4.10 (m, 26H), 4.09-3.75 (m, 26H), 3.73-3.23 (m, 19H), 2.41-2.21 (m, 4H).

ESI-HRMS analysis:

| For C₁₈₁H₁₉₂O₃₉ | Calculated | Observed |
|---|---|---|
| [M − H]⁻ | 2989.2996, 2990.3030, | 2989.0093, 2987.9497, |
| | 2991.3063, 2988.2963, | 2990.0205, 2986.9436, |
| | 2992.3097 | 2990.9836 |
| [M + Na]⁺ | 3013.2972, 3014.3006, | 3013.9944, 3012.9000, |
| | 3015.3039, 3012.2939, | 3014.9917, 3011.8901 |
| | 3016.3073 | |
| [M + NH₄]⁺ | 3008.3418, 3009.3452, | 3009.0344, 3008.0466, |
| | 3010.3485, 3007.3385 | 3010.0791, 3007.0481 |

### Sulfation of Compound (4):

In order to obtain the polysulfated derivatives of the present invention art known sulfation procedures can be used, such as for example provided in U.S. Pat. No. 2,923,704; U.S. Pat. No. 4,020,160; and U.S. Pat. No. 4,247,535, briefly;

Pyridine sulfonate (sulfur trioxide pyridine complex) was heated in a water bath to 70-80° C. Pyridine sulfonate (1000 mL) was added to a mechanically stirred vessel with a side arm, and maintained at 80° C. with a water bath. The reaction product of the previous step, i.e. compound 4 was added slowly with rapid stirring. The mixture was maintained at 80° C. with stirring for 2.5 hours, then water (500 mL) was added.

The resulting polysulfated product was characterised as having an average degree of sulfation of 17.09 S as determined by LC-MS.

### Example 2

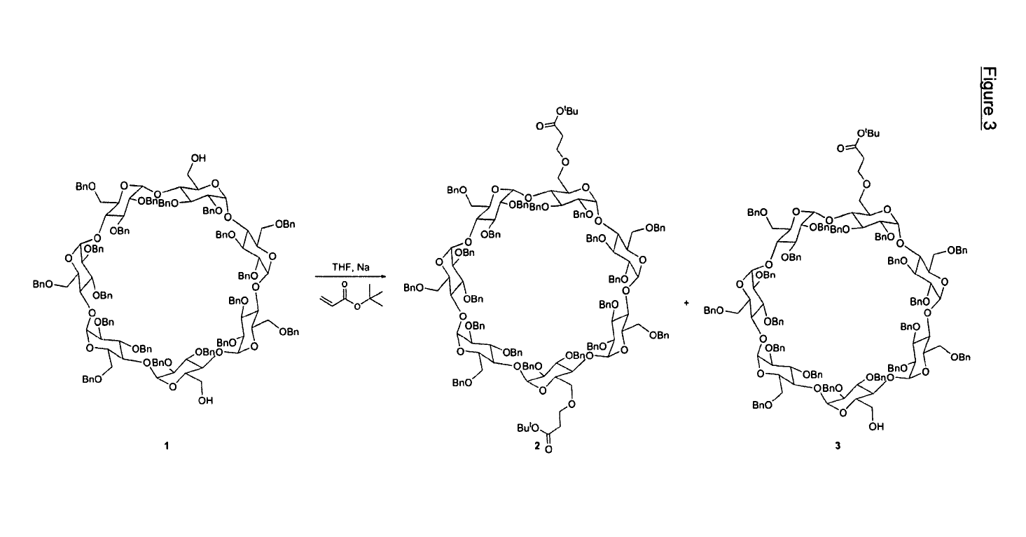

The synthetic procedure of this example follows the principles schematically shown in FIG. 2, and more precisely the details shown in FIGS. 3-5. The starting compound 1 was made according to the teaching of Pearce et al in Angew. Chem. Int. Ed. (2000) 39:3610-3612 for the regioselective di-de-O-benzylation of perbenzylated β-cyclodextrin.

### Addition of the Acrylate (FIGS. 2-3):

The procedure for the 1,4-addition of compound 1 to an acrylate was as follows. To a solution of compound 1 (1.0 g, 0.35 mmol) in dry tetrahydrofuran (THF) (10 mL) was added a freshly cut sodium metal (˜6 mg, 0.043 mmol) and stirred for 30 minutes. Tert-butyl acrylate (130 μL, 1.0 mmol) was added at 0° C. and stirred at room temperature for 24 hours. Reaction was quenched by addition of water. Products were extracted with ethyl acetate. The organic layer was dried over anhydrous MgSO₄ and the solvent removed under reduced pressure. Purification by column chromatography afforded two products (Thin layer chromatography 3:1 hexane-ethyl acetate, Rf−0.5, 300 mg, 27% and Rf−0.4, 300 mg, 29%).

The resulting product 2 was characterised as follows:

MS: calculated for C₁₈₉H₂₀₈O₃₉Na⁺: 3126.43; found 3126.51; and

¹H-NMR (peaks expressed in ppm): 6.6-7.4 (m, 95H, arom H), 3.0-5.9 (m, 91H), 2.2-2.4 (2 m, 4H, CH₂—CO), and 1.2-1.4 (2d, 18H, ^{t}Bu).

The resulting co-product 3 was characterised as follows:

MS: calculated for C₁₈₂H₁₉₆O₃₇Na⁺: 2996.34; found: 2997.43; and

¹H-NMR (peaks expressed in ppm): 6.9-7.2 (m, 95H, arom H), 3.2-5.3 (m, 89H), 2.2-2.4 (m, 2H, CH₂—CO), and 1.3 (d, 9H, ^{t}Bu).

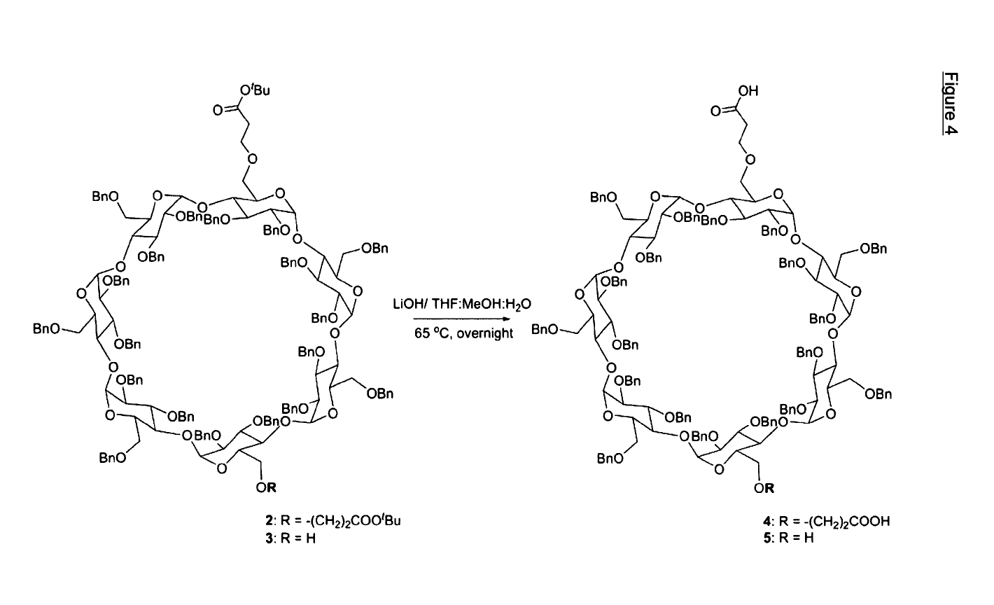

### Hydrolysis of Ester Groups (FIG. 4)

The synthetic procedure of this example follows the principles schematically shown in FIG. 4.

The detailed procedure for the hydrolysis of compounds 2 and 3 from the previous step was as follows.

To a stirring solution of 2 or 3 (0.013 mmol) in 2 mL of a THF:MeOH:H₂O (3:2:1) mixture was added LiOH.H₂O (10 mg) and the mixture was heated for 16 hours at 65° C. The reaction mixture was cooled, acidified with 1N HCl, and the product extracted with ethyl acetate. The organic layers were washed with brine, dried over anhydrous MgSO₄ and the solvent removed under reduced pressure. The residue was purified by column chromatography to afford products 4 and 5. which were characterised as follows:

compound 4: yield: 87%;

MS: calculated for C₁₈₁H₁₉₂O₃₉Na⁺ 3012.29; found: 3012.90

compound 5: yield: 95%;

MS: calculated for C₁₇₈H₁₈₈O₃₇Na⁺: 2940.27; found 2941.27.

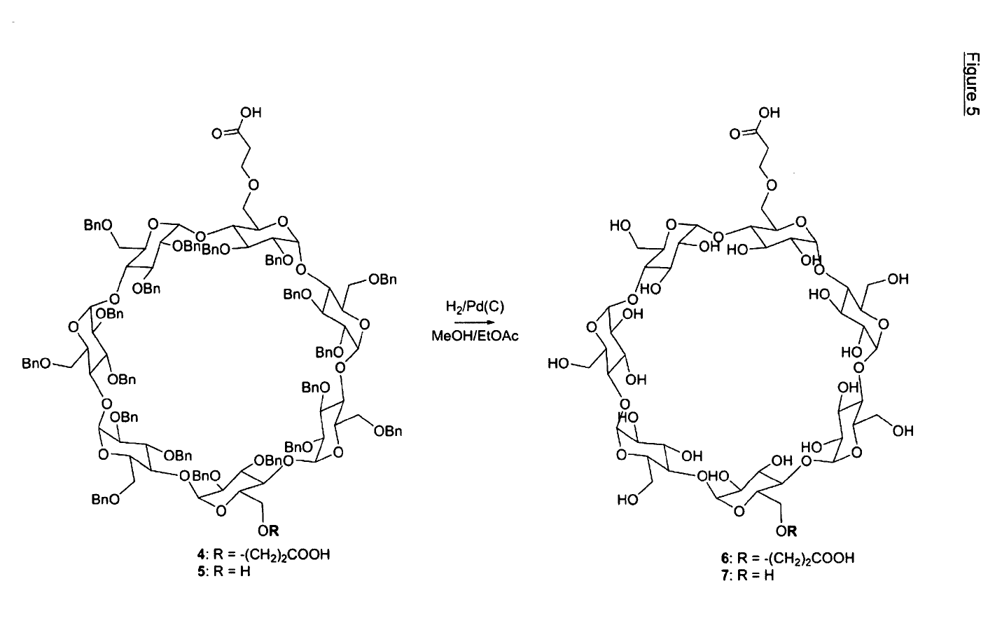

### Removal of Benzyl Protecting Groups (FIG. 5)

The synthetic procedure of this example follows the principles schematically shown in FIG. 5.

The detailed procedure for the removal of the benzyl protecting groups from compounds 4 and 5 of the previous step was as follows.

The respective compound 4 or 5 (0.013 mmol) was dissolved in a 1:1 MeOH-EtOAc solvent mixture (1.5 mL). Then, Pd—C (20 mg) and TFA (catalyst) were added and the mixture was kept stirring under hydrogen atmosphere for 3 days. Filtration and removal of the solvents afforded respectively:

6A,6D-O-di(ethylenecarboxylic acid)-β-cyclodextrin (6) in 78% yield, which was characterised as follows:

MS: calculated for C₄₈H₇₉O₃₉⁺: 1279.41; found: 1279.45; and

6A-O-(ethylenecarboxylic acid)-6D-OH-β-cyclodextrin (7) in 82% yield, which was characterised as follows:

MS: calculated for C₄₅H₇₅O₃₇⁺: 1207.40; found: 1207.43.

### Example 3

The synthetic procedure of this example follows the principles schematically shown in FIG. 2, and more precisely the details shown in Scheme 2 hereinbelow. The starting compound 1 was made (steps 1 & 2) according to the teaching of Pearce et al in Angew. Chem. Int. Ed. (2000) 39:3610-3612 for the regioselective di-de-O-benzylation of perbenzylated β-cyclodextrin.

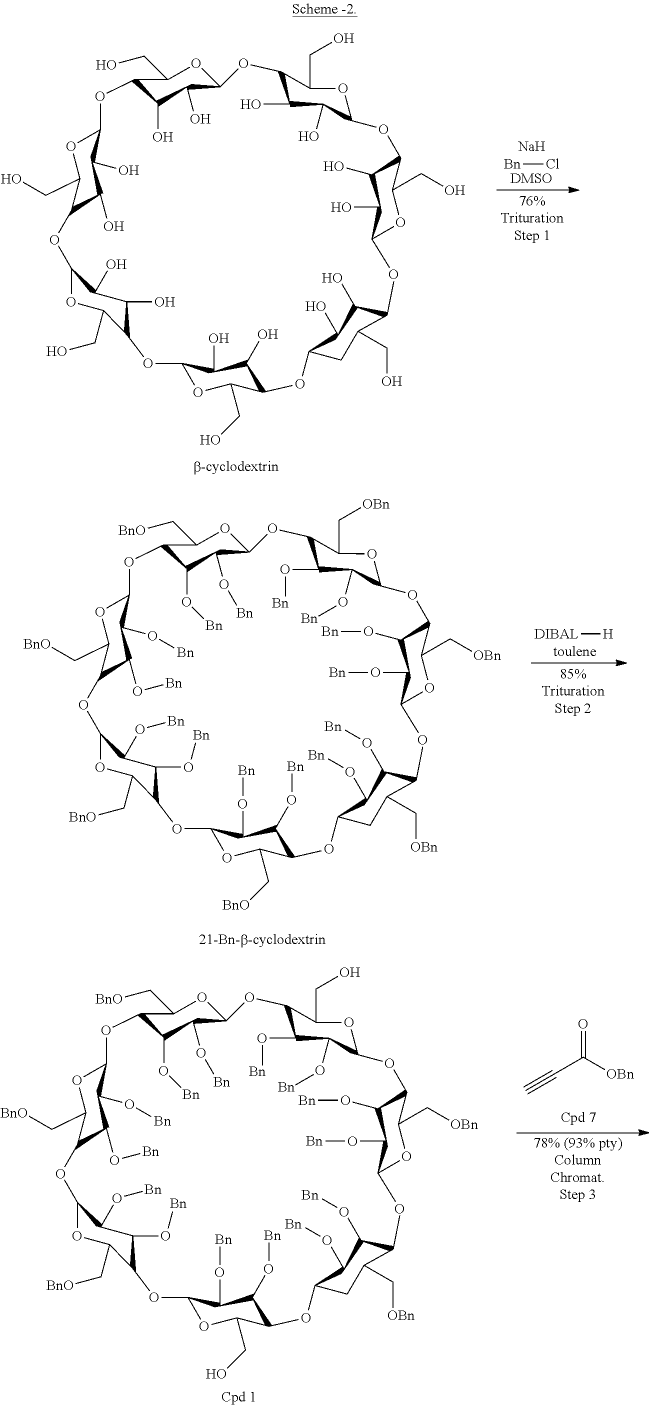

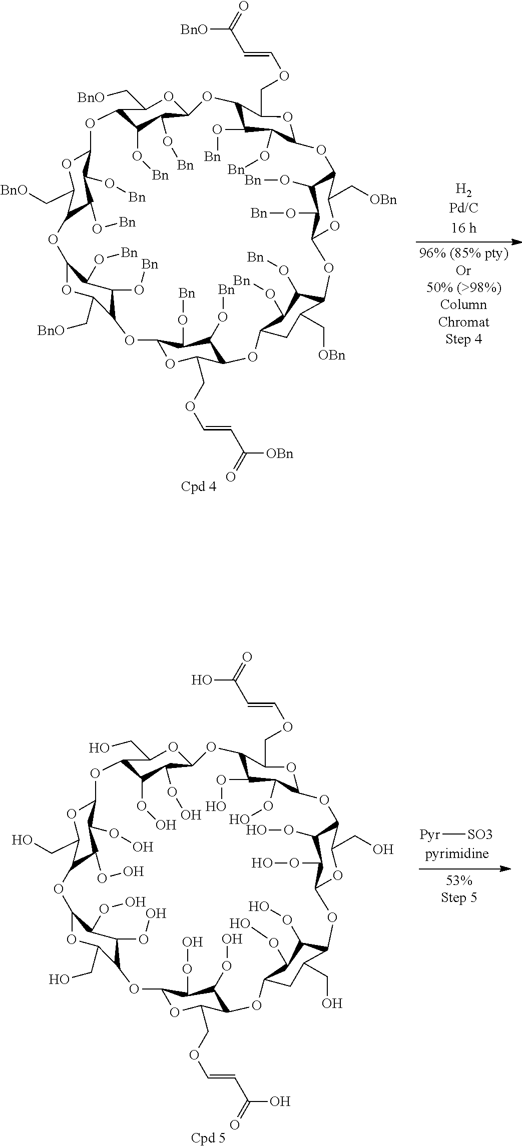

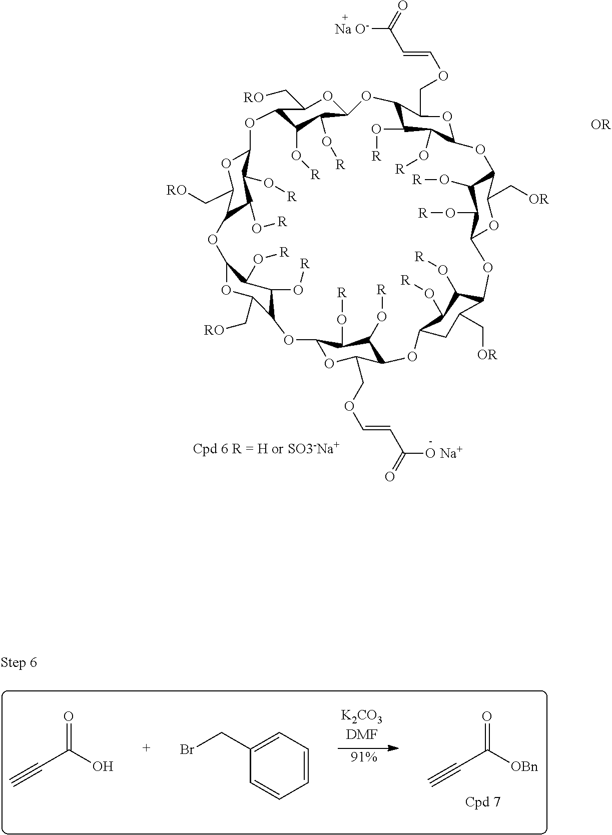

### Addition of the Propiolate (Step 3):

The procedure for the 1,4-addition of compound 1 to an propiolate ester was as follows. To a solution of compound 1 (4.0 g, 1.405 mmol) in dichloromethane (30 mL) was added N-methylmorpholine (0.772 mL, 7.02 mmol) and benzyl propiolate 7 (1.125 g, 7.02 mmol). The reaction mixture was stirred at ambient temperature. After 2 hours the starting material was consumed and a new major spot was visible on TLC. The reaction mixture was concentrated to dryness and purified by flash column chromatography to yield the desired product (Compound 4): 454 mg (68%), single spot on TLC. 1H-NMR in agreement with structure.

### Hydrogenation/Hydrogenolysis Reaction (Step 4):

In this hydrogenation/hydrogenolysis reaction the double bonds of the acrylate residues are reduced and all benzyl groups are removed.

An autoclave charged with compound 4 (1.98 g, 0.625 mmol); 10% Pd/c (200 mg, 0.188 mmol), tetrahydrofuran (20 mL) and water (10 mL) was stirred under 5 bar H₂ in overnight at ambient temperature. TLC indicated complete conversion (no UV-activity).

Alternatively one could use other supported palladium or platinum catalysts to reduce the C═C double bonds first. The reaction mixture was filtered over hyflo (rinsed with THF/water 1:1), concentrated to dryness and further dried with co-evaporating with diethyl ether to give an off-white solid: 680 mg (85%).

Purification by reversed phase column chromatography afforded the di-CE substituted compound 5 (HPLC Conditions: 50 g C18 silica, conditioned with 50% MeCN in water. 1:15 min, 1% MeCN in water. 2:70 min, 1-20% MeCN in water)

The resulting product 5 was characterised as follows:

LC-MS: >98% pure, mass in agreement with structure; ¹H-NMR (peaks expressed in ppm): 5.04-5.00 (m, 7H), 3.94-3.73 (m, 32H), 3.62-5.53 (m, 14H), 2.59 (t, 4H).

### Sulfation Reaction (Step 5):

In this final sulfation step, the same protocol was used as for example 1 above.

### Synthesis of Benzyl Propiolate (Step 6):

The benzyl propionate 7 for use in step 3 above is not commercially available, but readily prepared from propioloic acid and benzylbromide using art known procedures. The crude material (>98% GC-MS) can be kept at 4° C. for at least 4 weeks.

### Example 4

The synthetic procedure of this example follows the principles schematically shown in Scheme 3 hereinbelow. The starting compound 1 was made according to the teaching of Pearce et al in Angew. Chem. Int. Ed. (2000) 39:3610-3612 for the regioselective di-de-O-benzylation of perbenzylated β-cyclodextrin.

### Addition of the Acrylonitrile (Step 1)

The 1,4-addition with acrylonitrile can be accomplished by treatment of compound 1 with NaH in THF at 0° C. After addition of acrylonitrile the reaction mixture is stirred at room temperature overnight. After quenching with water the product can be extracted with ethyl acetate. After drying of the organic layer over sodium sulfate, filtration and concentration of the filtrate under reduced pressure, the desired product can be isolated by column chromatography.

### Alkaline Hydrolysis of the Nitrile (Step 2)

The carboxylic acid can be prepared by treatment of a DMSO solution of the cyano compound 2 (step 1) with an aqueous solution of sodium hydroxide at 70° C. for 16 hours. After cooling to ambient temperature and acidification with aqueous hydrochloric acid, the desired carboxylic acid 3 can be isolated by extraction with a suitable solvent (e.g. dichloromethane), washing of the organic layer with a saturated aqueous solution of sodium chloride, drying over sodium sulfate, filtration and concentration of the filtrate under reduced pressure.

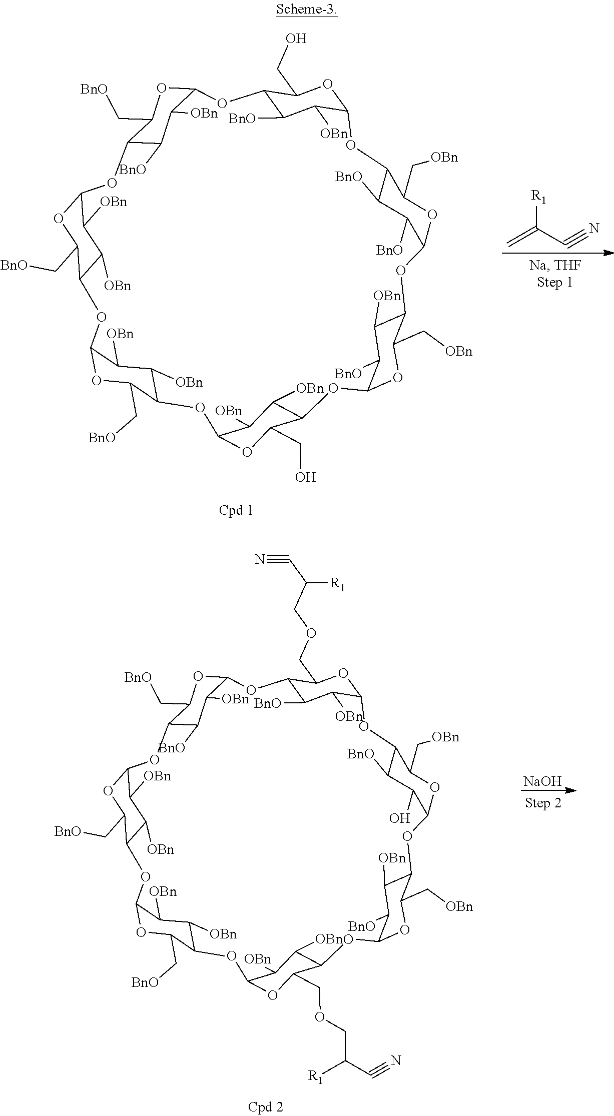

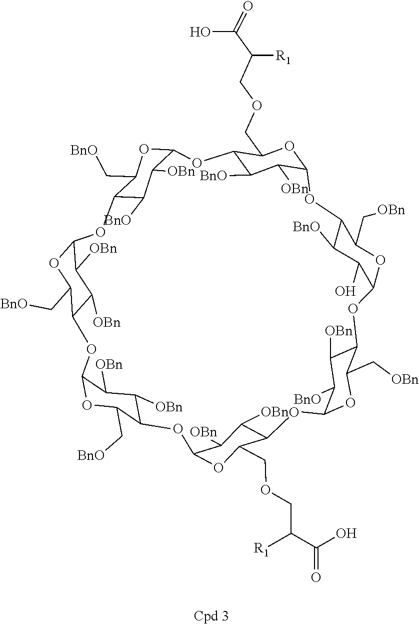

1. A fully substituted cyclodextrin derivative represented by any one of the structural formulae:
(BnO)ₘ—CD—[CH₂—O—R₃—C(═O)—OR′]ₙ (A)
(BnO)ₘ—CD—[CH₂—O—R₄—CN]ₙ (B)
wherein, in each of these structural formulae, Bn is benzyl, CD represents the cyclodextrin core, n is 1 or 2, and m+n is the total number of free hydroxyl groups of the unsubstituted cyclodextrin;
wherein:
R₃ and R₄ are each independently a divalent saturated or unsaturated C₁₋₁₀alkyl, wherein said C₁₋₁₀alkyl is optionally substituted with from 1 to 3 substituents selected from C₃₋₁₀ cycloalkoxy-C₁₋₄alkyl, aryloxy-C₁₋₄alkyl, C₁₋₄alkoxy-C₁₋₄alkyl, aryl-C₁₋₄alkoxy-C₁₋₄alkyl, aryl, aryl-C₁₋₄alkyl, carboxyl, cyano, fluoro, chloro, bromo, trifluoromethyl, ethoxy and phenyl, and
R′ is selected from the group consisting of hydrogen, C₁₋₆ alkyl, C₅₋₆cycloalkyl, aryl, aryl-C₁₋₄ alkyl, C₁₋₄ alkoxy-C₁₋₄alkyl, C₁₋₄alkylthio-C₁₋₄alkyl, aryl-C₁₋₄alkyl, and C₅₋₁₁cycloalkyl; wherein each aryl is optionally substituted with from one to two substituent selected from the group consisting of C₁₋₄ alkyl, C₁₋₄ alkoxy, phenoxy, benzyl, and phenyl;

2. The fully substituted cyclodextrin derivative of claim 1 represented by any one of the structural formulae:
(BnO)ₘ—CD—[CH₂—O—CH₂—R—C(═O)—OR′]ₙ (I)
(BnO)ₘ—CD—[CH₂—O—CH═R—C(═O)—OR′]ₙ (Ia)
(BnO)ₘ—CD—[CH₂—O—CH₂—CH(R₁)—C(═O)—OR″]ₙ (II)
(BnO)ₘ—CD—[CH₂—O—CH₂—CH(R₂)—CN]ₙ (III)
wherein, in each of these structural formulae, Bn is benzyl, CD represents the cyclodextrin core, n is 1 or 2, and m+n is the total number of free hydroxyl groups of the unsubstituted cyclodextrin;
wherein in formula (I) and (Ia):
R is a single bond or a saturated aliphatic chain having 1 to 4 carbon atoms, and R′ is selected from the group consisting of hydrogen, C₁₋₆ alkyl, C₅₋₆ cycloalkyl and aryl-C₁₋₄ alkyl;
wherein in formula (II):
R₁ is selected from the group consisting of C₁₋₆ alkyl, C₃₋₁₀ cycloalkoxy-C₁₋₄ alkyl, aryloxy-C₁₋₄ alkyl, C₁₋₄ alkoxy-C₁₋₄ alkyl, aryl-C₁₋₄ alkoxy-C₁₋₄ alkyl, aryl, aryl-C₁₋₄ alkyl, carboxyl, and cyano, and
R″ is selected from the group consisting of C₁₋₆ alkyl; C₁₋₄ alkoxy-C₁₋₄ alkyl; C₁₋₄ alkylthio-C₁₋₄ alkyl; aryl-C₁₋₄ alkyl wherein said aryl is optionally substituted with one substituent selected from the group consisting of C₁₋₄ alkyl, C₁₋₄ alkoxy, phenoxy and phenyl; aryl optionally substituted with one or two substituents selected from the group consisting of C₁₋₄ alkyl, C₁₋₄ alkoxy, phenyl and benzyl;
and C₅₋₁₁ cycloalkyl;
and wherein in formula (III) R₂ is selected from the group consisting of C₁₋₆ alkyl, fluoro, chloro, bromo, trifluoromethyl, cyano, ethoxy and phenyl.

3-5. (canceled)

6. A fully substituted cyclodextrin derivative according to claim 1, wherein n is 2 and both non-benzyl substituents are located each at carbon 6 of a glucopyranose unit.

7. A fully substituted cyclodextrin derivative according to claim 1, wherein n is 2 and both non-benzyl substituents are located each at carbon 6 of glucopyranose units A and D of the cyclodextrin core.

8. A mono- or di-substituted cyclodextrin derivative represented by any one of the structural formulae:
(HO)ₘ—CD—[CH₂—O—R₃—C(═O)—OH]ₙ (C)
(HO)ₘ—CD—[CH₂—O—R₄—C(═O)—OH]ₙ (D)
wherein, in each of these structural formulae, CD represents the cyclodextrin core, n is 1 or 2, and m+n is the total number of free hydroxyl groups of the unsubstituted cyclodextrin;
R₃ and R₄ are each independently a divalent saturated or unsaturated C₁₋₁₀ alkyl, wherein said C₁₋₁₀alkyl is optionally substituted with from 1 to 3 substituents selected from C₃₋₁₀ cycloalkoxy-C₁₋₄alkyl, aryloxy-C₁₋₄ alkyl, C₁₋₄ alkoxy-C₁₋₄ alkyl, aryl-C₁₋₄ alkoxy-C₁₋₄ alkyl, aryl, aryl-C₁₋₄ alkyl, cyano, carboxyl, fluoro, chloro, bromo, trifluoromethyl, ethoxy and phenyl.

9. The mono- or di-substituted cyclodextrin derivative of claim 8 represented by any one of the structural formulae:
(HO)ₘ—CD—[CH₂—O—CH₂—R—C(═O)—OH]ₙ (IV)
(HO)ₘ—CD—[CH₂—O—CH₂—CH(R₁)—C(═O)—OH]ₙ (V)
(HO)ₘ—CD—[CH₂—O—CH₂—CH(R₂)—C(═O)—OH]ₙ (VI)
wherein, in each of these structural formulae, CD represents the cyclodextrin core, n is 1 or 2, and m+n is the total number of free hydroxyl groups of the unsubstituted cyclodextrin;
wherein in formula (IV) R is a saturated aliphatic branched chain having 2 to 4 carbon atoms,
wherein in formula (V) R₁ is selected from the group consisting of C₁₋₆ alkyl, C₃₋₁₀ cycloalkoxy-C₁₋₄ alkyl, aryloxy-C₁₋₄ alkyl, C₁₋₄ alkoxy-C₁₋₄ alkyl, aryl-C₁₋₄ alkoxy-C₁₋₄ alkyl, aryl, aryl-C₁₋₄ alkyl, cyano and carboxyl, and
wherein in formula (VI) R₂ is selected from the group consisting of C₁₋₆ alkyl, fluoro, chloro, bromo, trifluoromethyl, carboxyl, ethoxy and phenyl.

10-12. (canceled)

13. A process for making a fully substituted cyclodextrin derivative according to claim 1 and being represented by any one of the structural formulae (A), (B), (I), (Ia), (II) and (III), comprising the steps of:
providing a primary alcohol or diol being the mono-de-O-benzylation or di-de-O-benzylation product of a perbenzylated cyclodextrin,
submitting said primary alcohol or diol to an etherification reaction, and
recovering said fully substituted cyclodextrin derivative represented by any one of the structural formulae (A), (B), (I), (Ia), (II) and (III).

14. A process according to claim 13, wherein said fully substituted cyclodextrin derivative is represented by the structural formula (A) and wherein the etherification reaction of step (b) proceeds via a Williamson ether synthesis by reacting said primary alcohol or diol with an ω-halo carboxylic acid ester or an ω-halo carboxylic acid represented by the structural formula X—R₃—C(═O)—OR′ wherein R₃ and R′ are as defined in the structural formula (A) and X is chloro, bromo or iodo.

15. A process according to claim 13, wherein said fully substituted cyclodextrin derivative is represented by the structural formula (I) and wherein the etherification reaction of step (b) proceeds via a Williamson ether synthesis by reacting said primary alcohol or diol with an ω-halo carboxylic acid ester or an ω-halo carboxylic acid represented by the structural formula X—CH₂—R—C(═O)—OR′ wherein R and R′ are as defined in the structural formula (I) and X is chloro, bromo or iodo.

16. A process according to claim 13, wherein said fully substituted cyclodextrin derivative is represented by the structural formula (Ia) and wherein the etherification reaction of step (b) proceeds via a Williamson ether synthesis by reacting said primary alcohol or diol with an ω-halo carboxylic acid ester or an ω-halo carboxylic acid represented by the structural formula X—CH═R—C(═O)—OR′ wherein R and R′ are as defined in the structural formula (Ia) and X is chloro, bromo or iodo.

17. A process according to claim 13, wherein said fully substituted cyclodextrin derivative is represented by the structural formula (II) and wherein the etherification reaction of step (b) proceeds via a 1,4-addition reaction between said primary alcohol or diol and an acrylic acid ester or an α-substituted acrylic acid ester.

18. A process according to claim 13, wherein said fully substituted cyclodextrin derivative is represented by the structural formula (B) and wherein the etherification reaction of step (b) proceeds via a 1,4-addition reaction between said primary alcohol or diol and acrylonitrile or an α-substituted acrylonitrile.

19. A process according to claim 13, wherein said fully substituted cyclodextrin derivative is represented by the structural formula (III) and wherein the etherification reaction of step (b) proceeds via a 1,4-addition reaction between said primary alcohol or diol and acrylonitrile or an α-substituted acrylonitrile.

20. A process for making a mono- or di-substituted cyclodextrin derivative according to claim 8 and being represented by any one of the structural formulae (C), (D), (IV), (V) and (VI), comprising the step of performing complete debenzylation of a fully substituted cyclodextrin derivative represented by one of the structural formulae (A), (B), (I) (Ia), (II) and (III) via catalytic hydrogenation.

21. A process according to claim 20, further comprising a hydrolysis step, before or after the complete debenzylation step, for converting a carboxylic ester moiety and/or a nitrile moiety into a carboxylic acid moiety.
